(19) United States
(12) Patent Application Publication
(10) Pub. No.: US 2017/0120498 A1
(43) Pub. Date: May 4, 2017

(54) METHODS OF MANUFACTURING A DIE BODY

(71) Applicant: CORNING INCORPORATED, CORNING, NY (US)

(72) Inventors: Thomas William Brew, Corning, NY (US); Steven John Kremer, Big Flats, NY (US); Christopher John Malarkey, Corning, NY (US); Bryan Michael Miller, Addison, NY (US)

(21) Appl. No.: 14/925,395

(22) Filed: Oct. 28, 2015

(51) Int. Cl. B29C 47/12

(52) U.S. Cl. CPC B29C 47/12; B29L 2031/757

(57) ABSTRACT

A method of making a die body configured to extrude a honeycomb body, the method comprising the step (I) of manufacturing a die body and the step (II) of predetermining an upstream slot width W1 of the die body such that the upstream slot width W1 is optimized while a root of each die pin includes a section modulus within a predetermined section modulus range. The method still further comprises the step (III) of predetermining a slot length L such that a pin stress is within a predetermined pin stress range.

### CROSS-REFERENCE TO RELATED APPLICATIONS

This application is a continuation of U.S. patent application Ser. No. 13/596,796 filed on Aug. 28, 2012, the content of which is relied upon and incorporated herein by reference in its entirety, and the benefit of priority under 35 U.S.C. §120 is hereby claimed

### FIELD

The present disclosure relates generally to methods of manufacturing a die body and, more particularly, to methods of manufacturing a die body including predetermining an upstream slot width and a slot length.

### BACKGROUND

It is known to manufacture die bodies with a plurality of feed holes and an array of pins that are spaced apart to define a honeycomb network of discharge slots. The die body may be mounted to portions of an extrusion die apparatus to extrude a green body from a batch of ceramic and/or ceramic-forming material. The green body is typically subsequently processed into a ceramic honeycomb substrate that may be used as a particulate filter and/or a catalytic carrier to process exhaust, for example, from a diesel engine.

### SUMMARY

In a first aspect, a method of making a die body configured to extrude a honeycomb body. The method comprises the step (I) of manufacturing a die body including a plurality of feed holes and an array of pins that are spaced apart to define a honeycomb network of discharge slots in fluid communication with the feed holes. Each discharge slot is manufactured with a slot length L. Each discharge slot is further manufactured with an upstream portion with an upstream slot width W1 in fluid communication with at least one feed hole and a downstream portion with a downstream slot width W2 in fluid communication with an extrusion face of the die body. The upstream portion and the downstream portion of each discharge slot are manufactured such that W1>W2. The method further includes the step (II) of predetermining the upstream slot width W1 such that the upstream slot width W1 is optimized while a root of each die pin includes a section modulus within a predetermined optimized section modulus range. The method also includes the step (III) of predetermining the slot length L such that a pin stress is within a predetermined pin stress range.

In accordance with one example of the first aspect, step (II) predetermines the upstream slot width W1 such that the upstream slot width W1 is maximized while the root of each die pin includes a section modulus within a predetermined maximized section modulus range.

In accordance with another example of the first aspect, the predetermined optimized section modulus range of step (II) includes a range of from about 9.3×10⁻⁶ cm³ to about 2.8×10⁻⁵ cm³.

In accordance with still another example of the first aspect, the predetermined pin stress range of step (III) includes a range of from about 240 MPa to about 750 MPa.

In accordance with yet another example of the first aspect, the predetermined pin stress range of step (III) is based on a calculated pin stress of a reference die body including a reference slot having a substantially constant reference slot width substantially equal to W2 along an overall length of the reference slot.

In accordance with another example of the first aspect, the predetermined stress range of step (III) is determined based by a calculated pin stress of the die body undergoing a cleaning procedure.

In accordance with yet another example of the first aspect, wherein step (I) includes manufacturing the die body as a monolithic single piece die body.

In accordance with still another example of the first aspect, wherein step (I) includes manufacturing the die body with L≦about 2.5 mm.

In accordance with a further example of the first aspect, wherein step (I) includes manufacturing the die body with W2≦about 255 μm.

In accordance with another further example of the first aspect, step (I) manufactures the upstream portion of the slot with a length L1 and the downstream portion of the slot with a length L2, wherein L≧about L1+L2.

In accordance with another example of the first aspect, step (I) manufactures each discharge slot with a transition region between the upstream portion and the downstream portion of the discharge slot, the transition region including a transition surface extending at an angle α from a surface of the upstream portion to a surface of the downstream portion of the discharge slot, wherein 45°≧α≧60°.

In accordance with still another example of the first aspect, step (I) manufactures at least one pin of the array of pins with a divot located within the downstream portion of the discharge slot.

Any of the examples of the first aspect listed above may be carried out alone or in any combination of the remaining examples of the first aspect listed above.

In accordance with a second aspect, a method of making a die body configured to extrude a honeycomb body is provided. The method includes the step (I) of manufacturing a die body including a plurality of feed holes and an array of pins that are spaced apart to define a honeycomb network of discharge slots in fluid communication with the feed holes. Each discharge slot is manufactured with a slot length L. Each discharge slot is further manufactured with an upstream portion with an upstream slot width W1 in fluid communication with at least one feed hole and a downstream portion with a downstream slot width W2 in fluid communication with an extrusion face of the die body. The upstream portion and the downstream portion of each discharge slot are manufactured such that W1>W2. The method further includes step (II) of predetermining the upstream slot width W1 to provide a root of each die pin includes a section modulus within a predetermined section modulus range of from about 9.3×10⁻⁶ cm³ to about 2.8×10⁻⁵ cm³. The method still further includes the step (III) of predetermining the slot length L such that a pin stress is within a predetermined pin stress range based on a calculated pin stress of a reference die body including a reference slot having a substantially constant reference slot width substantially equal to W2 along an overall length of the reference slot.

In accordance with an example of the second aspect, the predetermined pin stress range of step (III) includes a range of from about 240 MPa to about 750 MPa.

In accordance with another example of the second aspect, step (II) predetermines the upstream slot width W1 such that the upstream slot width W1 is maximized while the root of each die pin includes a section modulus within the predetermined section modulus range.

In accordance with still another example of the second aspect, step (I) includes manufacturing the die body as a monolithic single piece die body.

Any of the examples of the second aspect listed above may be carried out alone or in any combination of the remaining examples of the second aspect listed above.

In accordance with a third aspect, a method of making a die body configured to extrude a honeycomb body is provided. The method includes the step (I) of manufacturing a die body including a plurality of feed holes and an array of pins that are spaced apart to define a honeycomb network of discharge slots in fluid communication with the feed holes. Each discharge slot is manufactured with a slot length L. Each discharge slot is further manufactured with an upstream portion with an upstream slot width W1 in fluid communication with at least one feed hole and a downstream portion with a downstream slot width W2 in fluid communication with an extrusion face of the die body. The upstream portion and the downstream portion of each discharge slot are manufactured such that W1>W2. The method also includes the step (II) of predetermining the upstream slot width W1 to provide a root of each die pin includes a section modulus within a predetermined section modulus range of from about 9.3×10⁻⁶ cm³ to about 2.8×10⁻⁵ cm³. The method also includes the step (III) of predetermining the slot length L such that a pin stress is within a predetermined pin stress range determined based by a calculated pin stress of the die body undergoing a cleaning procedure.

In accordance with an example of the third aspect, the predetermined pin stress range of step (III) includes a range of from about 240 MPa to about 750 MPa.

In accordance with another example of the third aspect, step (II) predetermines the upstream slot width W1 such that the upstream slot width W1 is maximized while the root of each die pin includes a section modulus within the predetermined section modulus range.

In accordance with yet another example of the third aspect, step (I) includes manufacturing the die body as a monolithic single piece die body.

Any of the examples of the third aspect listed above may be carried out alone or in any combination of the remaining examples of the third aspect listed above.

### BRIEF DESCRIPTION OF THE DRAWINGS

These and other features, aspects and advantages of the claimed invention are better understood when the following detailed description is read with reference to the accompanying drawings, in which:

FIG. 1 is a schematic representation of an extrusion apparatus in accordance with aspects of the present disclosure;

FIG. 2 is an enlarged partial sectional perspective view of portions of a schematically illustrated die body of the extrusion apparatus of FIG. 1 in accordance with aspects of one example of the disclosure;

FIG. 3 is an enlarged partial sectional perspective view of the die body of FIG. 2;

FIG. 4 is an enlarged partial sectional view of a die body in accordance with another example of the disclosure; and

FIG. 5 is a flow chart illustrating example steps of methods of making a die body configured to extrude a honeycomb body.

### DETAILED DESCRIPTION

Aspects of the claimed invention will now be described more fully hereinafter with reference to the accompanying drawings in which example embodiments of the claimed invention are shown. Whenever possible, the same reference numerals are used throughout the drawings to refer to the same or like parts. However, the claimed invention may be embodied in many different forms and should not be construed as limited to the embodiments set forth herein. These example embodiments are provided so that this disclosure will be both thorough and complete, and will fully convey the scope of the claimed invention to those skilled in the art.

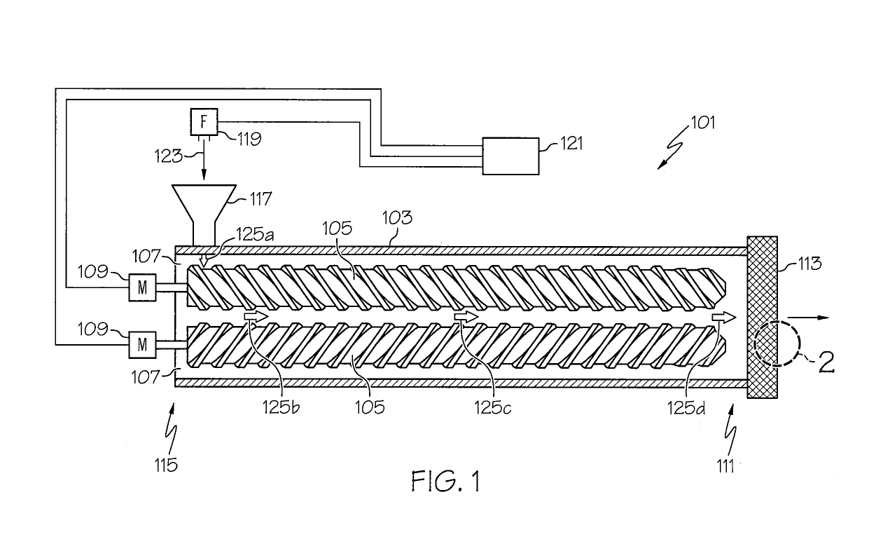

FIG. 1 provides a schematic representation of an extrusion apparatus 101 for processing a batch of materials. Various batch materials may be provided that comprise ceramic or ceramic forming material. The extrusion apparatus 101 can extrude green bodies of various shapes and sizes. In one example, the extrusion apparatus 101 can be used to extrude a honeycomb body that may be later fired into a honeycomb ceramic body. The honeycomb ceramic body can then be further processed as part of a filter to treat the exhaust stream of an engine. For instance, the honeycomb ceramic body can provide a particulate filter for a diesel or other engine type.

The extrusion apparatus 101 may include a barrel 103 with one or more screws 105 provided therein. In one example embodiment, the barrel 103 can be shaped to provide one or more chambers 107 that each house a screw 105 rotatably mounted within the chambers 107 at a central portion of the barrel 103. The screws 105 may be powered by one or more driving mechanisms 109 (e.g., motors). On a second, downstream end 111 of the extrusion apparatus 101, a schematically represented die body 113 is mounted to the barrel 103. The die body 113 is configured to extrude the batch material in the desired shape, e.g., a honeycomb body. Near an upstream end 115, a supply port 117 may be provided to allow the batch of materials from a feeder 119 to enter the chamber 107. As further illustrated, the extrusion apparatus 101 may include a control system 121. The control system 121 can be configured to adjust rotation of the screws 105 by way of the driving mechanisms 109 and/or adjust the feed rate of the batch material introduced by the feeder 119.

In operation, batch material may be introduced to the supply port 117 by the feeder 119 as indicated by arrow 123. As shown by arrow 125a, the batch material then enters into the barrel 103 and is propagated forward by the rotating screws 105 as shown at 125b, 125c such that the batch can contact and then enter the die body 113 at 125d. The rate at which the batch is fed into the supply port 117 (i.e., a feed rate) and/or the rate at which the screws 105 rotate (i.e., a rotational rate or screw speed) can be adjustable at any time during the flow of the batch through the extrusion apparatus 101.

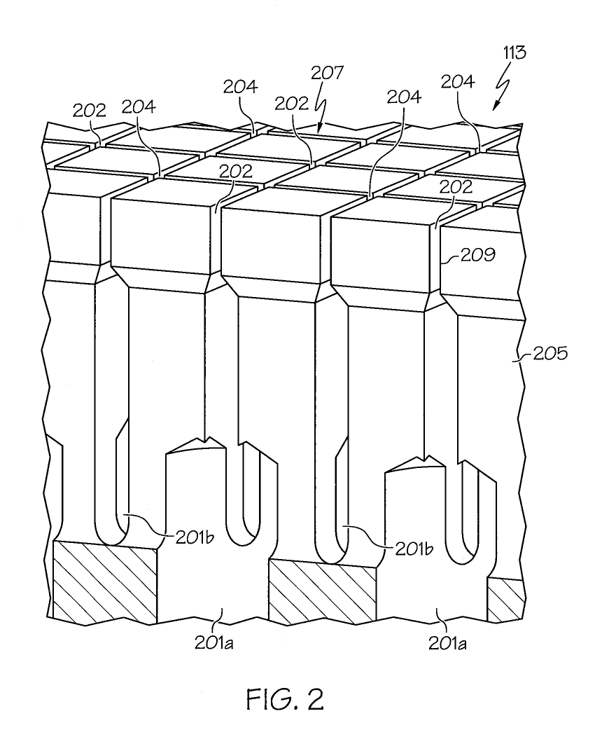

FIG. 2 illustrates optional aspects of one example die body 113 of the example extrusion apparatus 101 of FIG. 1. The die body 113 can include a monolithic single piece die body 113 including a plurality of feed holes 201a, 201b and an array of die pins 205 integrally formed together and spaced apart to define a honeycomb network 207 of discharge slots 209. As shown, all of the discharge slots 209 can be in direct fluid communication with at least one of the feed holes. For example, as shown in FIG. 2, rows of feed holes 201a can be offset from one another with each feed hole 201a having an axis extending along slot intersections 202. Further rows can also include feed holes 201b that are likewise offset from one another with each feed hole 201b having an axis extending along slot intersections 204.

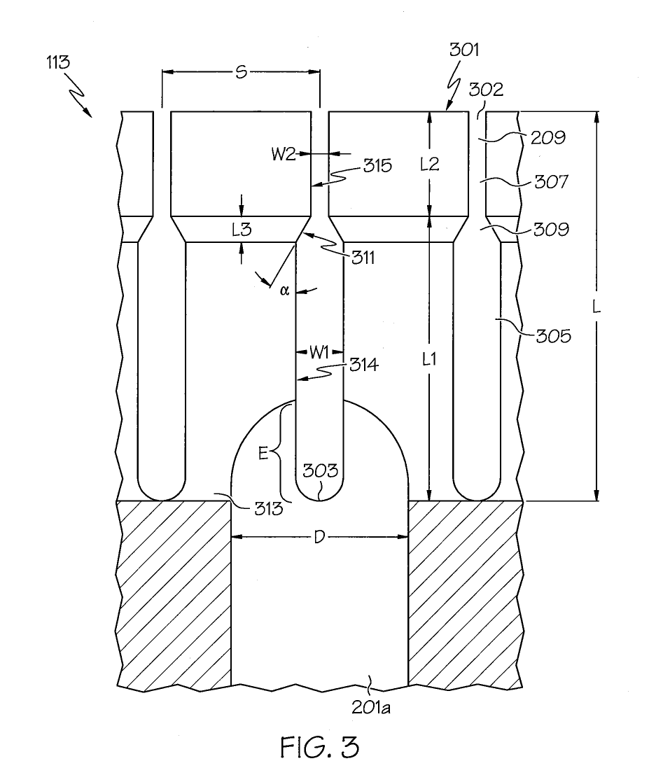

FIG. 3 illustrates example features of the example die body 113. The overall slot length L (also referred to as “slot length L” throughout the disclosure) can be defined between a downstream end 302 in fluid communication with an extrusion face 301 of the die body 113 and an upstream end 303 in fluid communication with at least one feed hole 201a. As shown, each discharge slot 209 can include an upstream portion 305 including the upstream end 303 and a downstream portion 307 including the downstream end 302. The upstream portion 305 is in fluid communication with the downstream portion 307 with the upstream portion 305 positioned substantially entirely upstream from the downstream portion 307.

The overall slot length L can at least include an upstream length L1 of the upstream portion 305 of the discharge slot 209 added to a downstream length L2 of the downstream portion 307 of the discharge slot 209. As such, the overall length L can be greater than or equal to about L1+L2.

Each discharge slot 209 can also include an optional transition region 309 between the upstream portion 305 and the downstream portion 307 of the discharge slot 209. The transition region 309, if provided can include a transition surface 311 extending at an angle α from a surface 314 of the upstream portion 305 to a surface 315 of the downstream portion 307 of the discharge slot 209. In some examples, 45°≦α≦60° although other transition angles may be used in further examples. The transition length L3 can be significantly less than L1 or L2. In such examples, the overall length L can still be greater than or equal to about L1+L2. In the illustrated example, the transition length L3 is considered part of the upstream length L1 wherein the overall length L is about equal to L1+L2. With more significant transition lengths, the transition length L3 may be considered separate from the upstream length L1 wherein the overall length L can be greater than or equal to about L1+L2+L3.

The upstream portion 305 can include an upstream width W1 that is greater than a downstream width W2 of the downstream portion 307 of the discharge slot 209. As such, a further shown in FIG. 3, W1 can be greater than W2 (i.e., W1>W2).

As discussed below, the upstream width W1 can be optimized, and in one example, even maximized while a root 313 of each die pin 205 includes a section modulus within a predetermined section modulus range. The upstream width W1 may be within a range of from about 0.2 mm to about 0.5 mm, such as from about 0.3 mm to about 0.4 mm although other upstream widths may be used in further examples.

The downstream width W2 can be selected to define the final thickness of the intersecting cell walls of honeycomb substrate being extruded from the die body 113 in use. For example, the downstream width W2 can be within a range of from about 0.04 mm to about 0.20 mm, such as from about 0.05 mm to about 0.15 mm, such as from about 0.06 mm to about 0.14 mm, although other downstream widths may be provided in further examples.

In further examples, the upstream length L1 can be related to the upstream width W1. For instance, in some examples, the upstream length L1 can be greater than or equal to about 5·W1. Likewise, the downstream length L2 can be related to the downstream width W2. For example, the downstream length L2 can be greater than or equal to about 5·W2, such as greater than or equal to about 7·W2.

In some examples, the overall length L can be less than or equal to about 3 mm such as from about 1 mm to about 2.6 mm, such as from about 2 mm to about 2.6 mm, although other lengths can be used in further examples. In some examples the upstream length L1 can be from about 1 mm to about 2 mm, such as from about 1.4 mm to about 1.7 mm, although various lengths can be used in further examples. In further examples, the downstream length L2 can be less than about 1.5 mm such as from about 0.4 mm to about 1 mm, although other lengths can be used in further examples.

In some examples, the upstream width W1 can be less than about 0.5 mm such as from about 0.2 mm to about 0.5 mm, such as from about 0.3 mm to about 0.45 mm, such as from about 0.3 mm to about 0.4 mm although other upstream widths may be used in further examples. In further examples, the downstream width W2 can be less than 0.3 mm, such less than about 0.2 mm, such as from about 0.06 mm to about 0.14 mm, although further lengths can be used in additional examples.

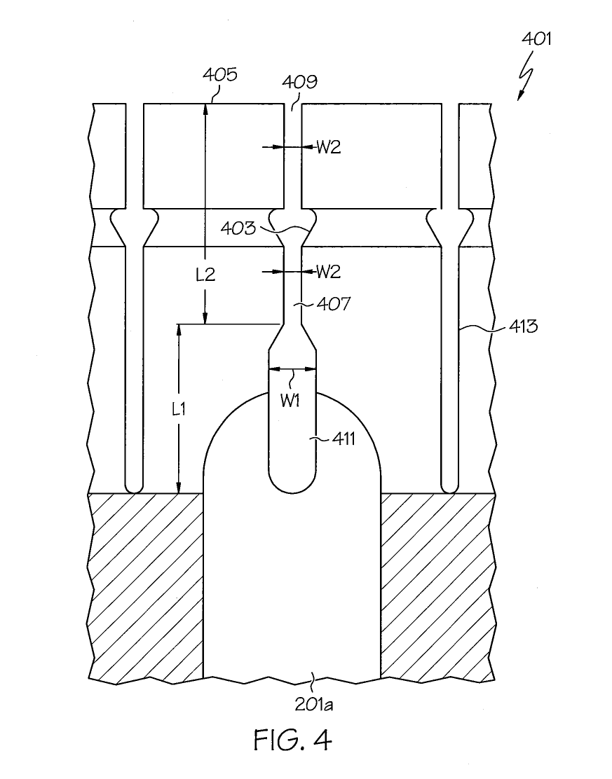

FIG. 4 illustrates another example die body 401 including at least one divot 403 that may be provided to surround at least one of the pins 405. As shown, the divot 403, if provided, can be located within a downstream portion 407 of a discharge slot 409. The discharge slot 409 can also include an upstream portion 411 including a width W1 greater than a width W2 of the downstream portion 407. As further shown, the discharge slot 409 with differing widths may be provided only with a selected number of the discharge slots with one or more remaining discharge slots 413 having substantially the same width along the length of the discharge slot outside the divot 403, if provided. In such designs, reduced manufacturing costs associated with the single width portion can be achieved while still providing a sufficient number slots with an enlarged upstream width W2 to reduce slot pressure and improve batch spreading.

Methods of making die bodies will now be described with reference to the die body illustrated in FIG. 3 with the understanding that similar, such as identical methods may be carried out to make the die body illustrated in FIG. 4 or other die bodies in accordance with aspects of the disclosure. Methods of the present disclosure can manufacture the die body 113 with a plurality of feed holes 201a, 201b and an array of die pins 205 that are spaced apart to define the honeycomb network 207 of discharge slots 209 in fluid communication with the feed holes 201a, 201b. Each discharge slot 209 is manufactured with a slot length L. Each discharge slot 209 is further manufactured with the upstream portion 305 including the upstream slot width W1 in fluid communication with at least one feed hole 201a, 201b. Each discharge slot 209 is still further manufactured with the downstream portion 307 including the downstream slot width W2 in fluid communication with the extrusion face 301 of the die body 113. As mentioned previously, the upstream portion 305 and the downstream portion 307 of each discharge slot are manufactured such that W1>W2.

The method of making the die bodies further includes the step of predetermining the upstream slot width W1 such that the upstream slot width W1 is optimized while a root 313 of each die pin includes a section modulus within a predetermined section modulus range. Optimizing the upstream slot width W1 can provide a sufficiently large section modulus to provide reduced back pressure and enhanced flow characteristics while providing enhanced strength due to an increased section modulus. In one example, although not required in all examples, optimizing the upstream slot width W1 can maximize the slot width W1. Maximizing the upstream slot width W1 can be beneficial to maximize lateral expansion and maximize reduced pressure of the batch material as it spreads into the discharge slots 209 within the expansion region E. Sufficient spreading of batch material within the network of discharge slots can reduce pressure of the batch material while permitting desirable knitting of the walls of the honeycomb substrate being extruded from the extrusion face 301 of the die body 113. However, while increasing the slot width W1 can be beneficial to facilitate spreading and reduce pressure of the batch material, the structural integrity of the die pin can be compromised by manufacturing the die body with an excessively wide upstream slot width W1. Indeed, increasing the upstream slot width W1 generally decreases the section modulus at the root 313 of the die pin 205. As such, it may be beneficial to manufacture the upstream slot width W1 to a maximum size while maintaining the section modulus of the root 313 of the die pin 205 within a predetermined section modulus range. In further examples, it may be desirable to optimize the slot width W1, without necessarily maximizing the slot width, to provide further strength to the die pins while still providing the benefits of an increased size of the upstream slot width W1. In one example, the upstream slot width W1 can be optimized, such as maximized, while the root 313 of the die pin 205 includes a section modulus within a section modulus range of from about 9.3×10⁻⁶ cm³ to about 2.8×10⁻⁵ cm³. Maintaining the root of the die pin within the section modulus range discussed above can help maintain structural integrity of the die body under various operating conditions. Moreover, cleaning procedures are frequently performed to periodically clean the die body from batch material. Typically, such cleaning procedures can expose the die pins to significant forces applied by pressurized cleaning fluid during the cleaning procedure. Providing the root 313 of the die pin 205 a section modulus within the range of section modulus discussed above can provide the die pins with sufficient rigidity to resist the bending forces that may otherwise cause failure of the die pins at the root 313.

The method of making the die bodies can further include the step of predetermining the overall length L of the discharge slot such that a pin stress is within a predetermined pin stress range. There can be a benefit in maintaining a sufficiently large overall slot length L to permit sufficient knitting of the walls of the honeycomb substrate prior to being extruded from the extrusion face 301 of the die body 113. However, increasing the overall slot length L can undesirably increase the operating pressure of the honeycomb extrusion apparatus and can also increase a predetermined pin stress; thereby resulting in potential structural failure of the die pins and increase operating costs. As such, example methods can predetermine the overall length L of the discharge slot to minimize the length L to reduce pin stress to within a predetermined pin stress range while still providing a sufficiently long overall length L to permit appropriate knitting of the walls of the honeycomb structure.

In one example, the predetermined pin stress range can be from about 240 MPa to about 750 MPa. In further examples, the predetermined pin stress range can be based on a calculated pin stress of a reference die body including a reference slot having a substantially constant reference slot width substantially equal to W2 along an overall length of the reference slot. For example, an existing die body may include a substantially constant width along substantially the entire slot length. In such examples, the existing die body may be analyzed under a slot width substantially equal to the downstream slot width W2 of the downstream slot portion 307 to determine a pin stress under certain operating or cleaning procedures. Such pin stress may then be used as the predetermined pin stress range to maximize the overall length L of the discharge slot 209 in the die body 113. As such, the overall length L of the discharge slot 209 may be minimized while still maintaining similar pin stress used with an existing die body that may have a substantially constant slot width.

In still further examples, the predetermined stress range can be determined based on a calculated pin stress of the die body undergoing a cleaning procedure. For example, an existing design with an acceptable pin design may be modeled to calculate the pin stress of the die body undergoing a cleaning procedure. This predetermined stress can then be used to help determine the maximum length L of the discharge slot that may be achieved while maintaining the pin stress within a predetermined pin stress range.

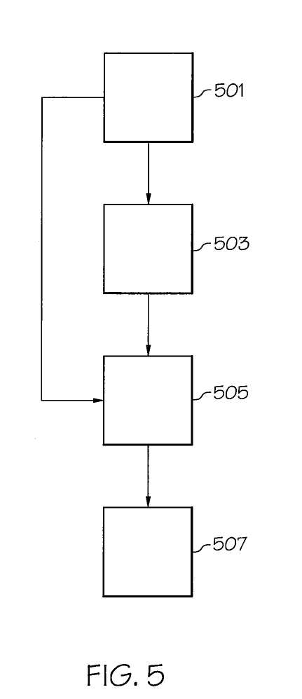

FIG. 5 represents example steps of manufacturing a die body. The method can include the step 501 of predetermining the upstream slot width W1 as discussed above. More particularly, the upstream slot width W1 is predetermined such that the upstream slot width W1 is optimized, such as maximized, while a root of each die pin includes a section modulus within a predetermined section modulus range, such as from about 9.3×10⁻⁶ cm³ to about 2.8×10⁻⁵ cm³ although other ranges may be possible in further examples.

The method can then optionally proceed to step 503 of obtaining the predetermined stress range based on a calculated pin stress. In a first example, the predetermined pin stress range of step is based on a calculated pin stress of a reference die body including a reference slot having a substantially constant reference slot width substantially equal to W2 along an overall length of the reference slot. In a second example, in addition or alternative to the first example, the predetermined stress range is determined based by a calculated pin stress of the die body undergoing a cleaning procedure.

Next, the method can proceed to step 505 of predetermining the slot length L such that a pin stress is within a predetermine pin stress range. In some examples, the predetermined stress range is from about 240 MPa to about 750 MPa. In further examples, the method can proceed directly from step 501 of predetermining the upstream slot width W1 to the step 505 of predetermining the slot length L. In further examples, also not illustrated in FIG. 5, the method can begin with step 505 and then proceed to optional step 503 or directly to step 501. In either case, once the upstream slot width W1 and the slot length L are predetermined, the upstream slot width W1 and the slot length L, together with the remaining die body parameters can be used to manufacture the die body during step 507.

Various manufacturing techniques may be used to manufacture the die body including wired EDM, plunge EDM or an abrasive slitting operation. The die body can be manufactured with the plurality of feed holes 201a, 201b and the array of die pins 205 that are spaced apart to define the honeycomb network 207 of discharge slots 209 in fluid communication with the feed holes 201a, 201b. Each discharge slot is manufactured with the predetermined slot length L. Each discharge slot is further manufactured with the upstream portion 305 with the upstream slot width W1 in fluid communication with at least one feed hole 201a, 201b and the downstream portion 307 with the downstream slot width W2 in fluid communication with the extrusion face 301 of the die body 113. The upstream portion 305 and the downstream portion 307 are manufactured such that W1>W2.

Example methods of making a die body will now be described with respect to the table below

TABLE 1

| | | | | | | | | Handling- |
|---|---|---|---|---|---|---|---|---|
| | | | | | | | Section | Cleaning |
| | | | | | | | Modulus | Pin |
| | Web Thickness | L1 | L2 | W1 | W2 | L | of Pin Root | Stress % |
| Sample # | (mm) | (mm) | (mm) | (mm) | (mm) | (mm) | (cm³) | Yield |
| 1 | 0.114 | 1.52 | 0.800 | 0.305 | 0.114 | 2.44 | 1.52E−05 | 49 |
| 2 | 0.140 | 1.42 | 0.978 | 0.406 | 0.140 | 2.54 | 2.80E−05 | 28 |
| 3 | 0.140 | 1.42 | 0.978 | 0.406 | 0.140 | 2.54 | 2.10E−05 | 38 |
| 4 | 0.114 | 1.65 | 0.800 | 0.330 | 0.114 | 2.57 | 9.70E−06 | 81 |
| 5 | 0.089 | 1.65 | 0.622 | 0.330 | 0.089 | 2.36 | 9.30E−06 | 80 |
| 6 | 0.064 | 1.65 | 0.445 | 0.330 | 0.064 | 2.16 | 1.40E−05 | 47 |
| 7 | 0.089 | 1.65 | 0.622 | 0.330 | 0.089 | 2.36 | 1.30E−05 | 55 |

For each sample, the die body parameters can be modeled to determine the section modulus of the root 313 of the die pin 205 as well as the handling-cleaning pin stress % yield. Initially, as shown in the table, the upstream slot width W1 can be optimized (e.g., from about 0.3 mm to about 0.4 mm) while the root of the die pin includes a section modulus illustrated in the table that is within a predetermined section modulus range (e.g., from about 9.3×10⁻⁶ cm³ to about 2.8×10⁻⁵ cm³). Next, the slot length L can be minimized (e.g., from about 2.2 mm to about 2.6 mm) to provide sufficient knitting of the walls while reducing a pin stress within a predetermined pin stress range (e.g., with a predetermined pin stress range associated with a Handling-Cleaning Pin Stress % Yield of from about 28 to about 81).

Aspects of the disclosure can provide enhanced knit strength of the cell walls of a substrate that may prevent cracking from occurring subsequent drying and firing processes. Moreover, relatively thin cell walls can be achieved by downstream slot portions with a relatively small downstream width without raising the operating pressure in the slot region of the die body to prohibitively high levels. Indeed, reduced pressures from about 10% to over 30% from standard pressures may be achieved to result in higher throughput capacity; thereby reducing production costs.

By increasing the upstream slot width W1 relative to the downstream slot width W2, spreading of the batch and the spread angle can be more precisely controlled ensuring the unfed intersection areas (i.e., see intersections not labeled 202 or 204 in FIG. 2) have comparable strength to the fed intersection zones (see 202, 204). In addition, this increased upstream slot width (W1) allows the overall length L of the discharge slot 209 to be reduced, thereby improving manufacturing variability and speeding up the manufacture of the die body 113. The reduced length L of the discharge slot 209 coupled with its increased width decreases the pressure drop in this hole / slot intersection of the expansion zone E (see FIG. 3) and also in the overall slot zone significantly. In addition, fluid flow modeling confirmed by actual test runs has shown that this wider slot zone can dampen out flow variability that may be introduced to the slot. In some cases, the modeling confirmed by actual test runs showed a 50% flow velocity difference being damped down to under 5%. This type of design is not limited to one expansion and constriction zone. Rather, any number of expansion/constriction zones can be placed in the die design to optimize the aforementioned die design parameters (knit strength, pressure drop and/or flow uniformity). Aspects of the disclosure can improve uniformity of batch flow through the die by as much as 10× which greatly reduces the impact of process/material variability and die tolerance variability.

It will be apparent to those skilled in the art that various modifications and variations can be made to the described embodiments without departing from the spirit and scope of the claimed invention. Thus, it is intended that the present claimed invention cover the modifications and variations of the embodiments described herein provided they come within the scope of the appended claims and their equivalents.

What is claimed is:

1. A honeycomb extrusion die comprising:
a die body comprising an array of pins that are spaced apart such that outer surfaces of the pins define a honeycomb network of discharge slots, the die body being provided with a plurality of feed holes, wherein the discharge slots are in fluid communication with the feed holes, wherein the outer surfaces of at least one pair of adjacent pins define a discharge slot therebetween, the discharge slot comprising an upstream slot width portion of width W1 adjacent at least one of the feed holes, a downstream slot width portion of width W2 which is downstream of the upstream slot width portion, a divot portion having a width greater than W2, and a distal slot width portion having a width less than the width of the divot portion.

2. The honeycomb extrusion die of claim 1 wherein the distal slot width portion has a width W2.

3. The honeycomb extrusion die of claim 1 wherein the distal slot width portion has a width other than W2.

4. The honeycomb extrusion die of claim 1 wherein at least some of the discharge slots have substantially the same width along the length of the discharge slot other than at the divot portions.

5. The honeycomb extrusion die of claim 1 wherein the distal slot width portion extends to an end surface of at least one of the at least one pair of adjacent pins.

6. The honeycomb extrusion die of claim 5 wherein the divot portion is located at a depth from the end surface.

7. The honeycomb extrusion die of claim 1 wherein the width W1 of the upstream slot width portion is narrower than the width of an adjacent feed hole.

8. A honeycomb extrusion die apparatus comprising:
a die body comprising an array of pins that are spaced apart such that outer surfaces of the pins define a honeycomb network of discharge slots, the die body being provided with a plurality of feed holes, wherein the discharge slots are in fluid communication with the feed holes, wherein the outer surfaces of at least one pair of adjacent pins define a discharge slot therebetween, the discharge slot comprising an upstream slot width portion of width W1 adjacent at least one of the feed holes, a downstream slot width portion of width W2 which is downstream of the upstream slot width portion, a divot portion having a width greater than W2, and a distal slot width portion having a width less than the width of the divot portion.

9. The honeycomb extrusion die apparatus of claim 8 wherein the distal slot width portion has a width W2.

10. The honeycomb extrusion die apparatus of claim 8 wherein the distal slot width portion has a width other than W2.

11. The honeycomb extrusion die apparatus of claim 8 wherein at least some of the discharge slots have substantially the same width along the length of the discharge slot other than at the divot portions.

12. The honeycomb extrusion die apparatus of claim 8 wherein the distal slot width portion extends to an end surface of at least one of the at least one pair of adjacent pins.

13. The honeycomb extrusion die apparatus of claim 12 wherein the divot portion is located at a depth from the end surface.

14. The honeycomb extrusion die apparatus of claim 8 wherein the width W1 of the upstream slot width portion is narrower than the width of an adjacent feed hole.
